(19) United States
(12) Patent Application Publication
(10) Pub. No.: US 2011/0304427 A1
(43) Pub. Date: Dec. 15, 2011

(54) CLOSING-IN SENSOR FOR LOCKING/UNLOCKING A DOOR LEAF

(75) Inventors: Jean- Francois Leon, Creteil Cedex (FR); Jean-Michel Tessier, Creteil Cedex (FR)

(73) Assignee: VALEO SECURITE HABITACLE, Creteil Cedex (FR)

(21) Appl. No.: 13/059,169

(22) PCT Filed: Aug. 27, 2009
(86) PCT No.: PCT/EP09/61089

§ 371 Date: Jun. 20, 2011

(30) Foreign Application Priority Data
Aug. 27, 2008 (FR) 0804721
Aug. 29, 2008 (FR) 0804773

(51) Int. Cl. G08B 29/00

(52) U.S. Cl. 340/5.72

(57) ABSTRACT

The invention relates to a closing-in or presence or detection capacitive sensor (6) for locking/unlocking a door leaf (4), in particular for a vehicle. More precisely, the closing-in capacitive sensor is to be integrated into the handle (1) of a door leaf for locking/unlocking the same. The sensor includes at least one electrode and at least one metal shielding member (10) formed on a printed circuit (8) so as to create a detection area (5) for detecting the presence of a user.

The present invention relates to a closing-in, presence or detection sensor for locking/unlocking a door leaf, in particular for a vehicle.

More precisely, the invention relates to an approach sensor, in particular but not exclusively of the capacitive type, intended to be integrated in the handle of a vehicle door leaf.

This type of sensor makes it possible to design “hands free” systems for locking/unlocking a vehicle door based on the detection of a user's hand, for example, in the vicinity of the handle.

Said detection is carried out by means of a measuring electrode coupled with a reference electrode in such a way as to be able to detect a variation as a hand approaches. This variation then initiates a communication between a recognition device situated on the vehicle and a portable identifier carried by the user in such a way as to allow a locking/unlocking of the door leaf only in the case of authentication of an authorized identifier. According to another hands free system, the detection can also be carried out with a prior authentication of the vehicle interrogating the authorized identifiers at regular intervals.

In general, the capacitive approach sensor is arranged inside a handle in order to create a localized electric field.

The current problem with this type of sensor is that it forms a rather extensive detection zone around the handle causing undesired detections. In fact, the electric field formed by its electrodes extends beyond the desired detection zones and, in this instance, towards the outside of the handles thus giving rise to unwanted triggerings of the locking/unlocking of the door leaf. Moreover, an asymmetry of the electric field has been observed in the vertical plane, with respect to the door leaf, thus generating a functional asymmetry, for example between a left handle and a right handle.

That is why there has already been proposed, according to the European patent application Number EP1384845, to provide the capacitive electrodes with a screen component connected to ground. This screen component is placed on an outside face of the detection unit and extends facing at least one electrode.

According to a second state of the prior art, and in particular according to the Japanese patent application Number JP2004169426, there is disclosed a screen component kept spaced in a parallel manner from a printed circuit via a support.

However, among the abovementioned sensors, none of them make it possible to provide a directive and accurate capacitive sensor for the locking/unlocking of a vehicle door leaf.

The purpose of the present invention is to solve this problem by providing a directive sensor making it possible to obtain a variation detection zone which is reliable and limited to within a defined space making it possible to avoid any parasitic detection.

Moreover, the present invention makes it possible to reduce the overall dimensions of the detection system and therefore of the handle.

Moreover, the present invention makes it possible to reduce the manufacturing cost of such handles comprising such an approach detector as well as to facilitate their assembly.

Favorably, the present invention makes it possible to obtain a symmetrical detection in the vertical plane with respect to the door leaf thus making it possible to facilitate the production of handles comprising such a sensor.

For this purpose, the subject of the present invention is a capacitive approach sensor intended to be integrated in a door leaf handle, in particular for a vehicle, for the purpose of its locking/unlocking, comprising at least one electrode formed on a printed circuit in order to create a zone for detecting the presence of a user, characterized in that it comprises at least one metal shielding member formed on said printed circuit.

Advantageously, said shielding member forms one of the faces of the printed circuit.

More precisely, said shielding member extends longitudinally and in a parallel manner over the whole length of said at least one electrode and is constituted by conductive material.

Alternatively, the shielding member has an openwork structure able to be in the form of a conductive mesh.

Preferably, said metal shielding member is constituted by copper.

Advantageously, said shielding member is referenced at an electric potential or is floating.

Preferably, said printed circuit can have, on one of its faces, a reference electrode surrounded by a measuring electrode and, on its other face, a metal shielding member.

Advantageously, the sensor according to the invention comprises means of detection which are asymmetrical in the horizontal plane and symmetrical in the vertical plane, with respect to said door leaf.

Other features and advantages of the invention will emerge during the following description of an embodiment of the approach sensor given by way of example with reference to the appended drawings in which:

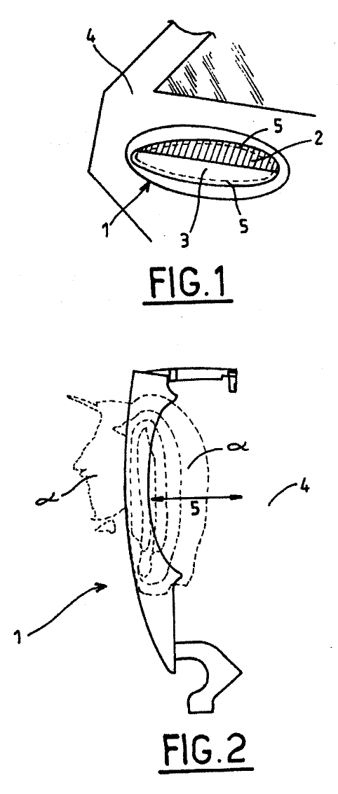

FIG. 1 is a partial diagrammatic view of the exterior of a vehicle door leaf;

FIG. 2 is a plan view of a handle and of the electric field generated by a sensor according to the prior art;

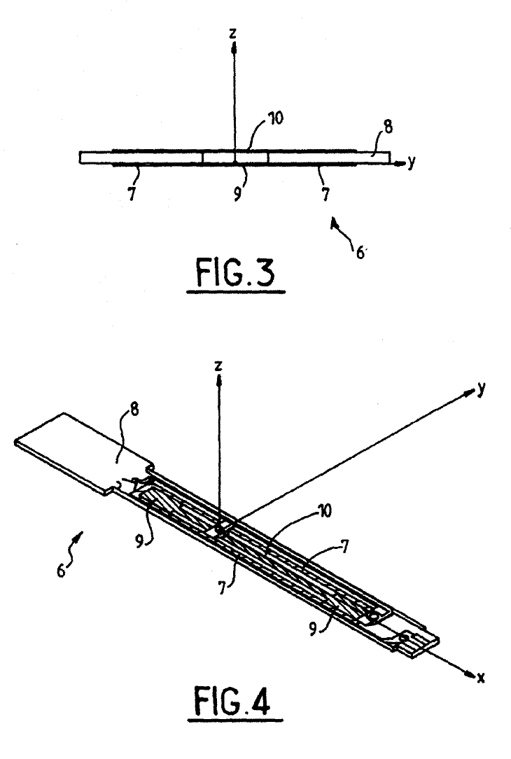

FIG. 3 is a perpendicular cross-sectional view of the sensor according to the invention;

FIG. 4 is a perspective view of the sensor according to the invention;

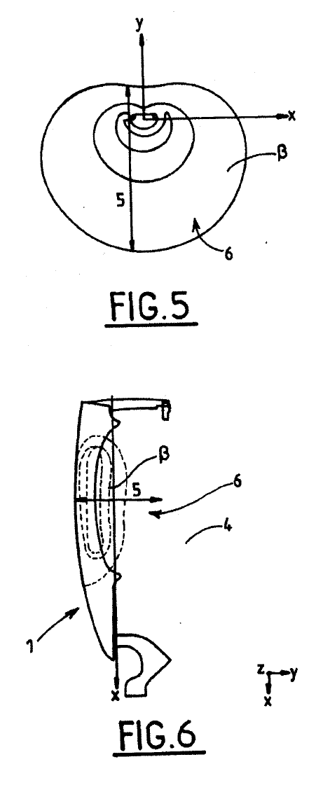

FIG. 5 is a cross-sectional view of the electric field generated by the sensor according to the invention;

FIG. 6 is a plan view of a handle and of the electric field generated by the sensor according to the invention.

FIG. 1 is a partial diagrammatic view of the exterior of a vehicle door leaf.

FIG. 1 diagrammatically shows a handle 1, of the “hands free” vehicle access type, formed by a grasping part 2 and a fixed part 3 with respect to the door leaf 4, such as a vehicle door. This figure also shows a zone 5 of detection of a user.

Before molding or constituting the final handle, provision is made for integrating a capacitive directive approach sensor 6 according to the present invention in order to allow the detection of all or part of a hand or any other object belonging to a user in the desired detection zone 5.

Said sensor allows a detection by means of the coupling of at least one measuring electrode 7 and at least one reference electrode 9, formed on a printed circuit 8.

More precisely, said reference electrode can be of the active or passive type.

Preferably, said reference electrode is an excitation electrode, which applies, or pulses at regular intervals, an excitation to the electric field.

In an embodiment of the invention, the capacitive sensor which is integrated in the handle comprises only one single electrode. The electrode is then a reference electrode or a measuring electrode. The second electrode present outside of the handle is, for example, a component of the bodywork or the whole of the bodywork; said component or said whole preferably being connected to ground. The ground surface surrounding the vehicle can also be used in the capacitive detection, by its behavior as a grounded electrode.

In these different embodiments, the electric field variations due to the presence of the hand are measured between the electrode disposed in the handle and the electrode constituted by the bodywork and/or the ground surface.

The detection zone 5 of the electrodes 7 and 9 of the capacitive approach sensor 6 must allow a detection in the inside part of said handle 1. In other words, the inside part of the handle 1 corresponds to the lateral part of the handle most in contact with the door leaf 4 of the vehicle.

More precisely, said detection zone 5 is situated facing and parallel with said door leaf, in such a way as to detect any detection in the lower and upper vicinities of the inside part of the handle 1 for the purpose of locking/unlocking said door leaf.

In general, the face of the capacitive approach sensor 6 comprising said electrodes is disposed in the inside part of the handles 1 and facing said door leaf, in order to create a localized electric field in said desired detection zone 5.

FIG. 2 is a plan view of a handle and of the electric field generated by its sensor, according to the prior art.

This figure shows levels of the electric field lines a simulated in the case where the handle comprises an approach sensor according to the prior art. Said electric field generated by the electrodes included in the vehicle's handle overflows or extends in an asymmetrical manner from the handle towards its outside part, corresponding to the lateral part of the handle least in contact with the door leaf of the vehicle, and this can result in undesired detections.

FIGS. 3 and 4 show a sensor according to the invention in a perpendicular cross-sectional view and in a perspective view respectively.

The present invention overcomes the disadvantages of the prior art by proposing to place or form at least one metal shielding member or screen 10 directly on the printed circuit 8, of the “PCB” type for example.

More precisely, the shielding member 10 is fixed to one of the faces of the printed circuit 8. In other words, the shielding member 10 can form one of the faces of said printed circuit.

As shown in FIG. 3, provision can be made for keeping the metal shielding member held firmly and directly on the upper face of the printed circuit 8 and for placing said electrodes 7 and 9 on its lower face. The sensor is then integrated in said handle in such a way that it is disposed facing said door leaf.

According to another configuration of the invention, the printed circuit 8 has on one of its faces a reference electrode 9 surrounded by or sandwiched by a measuring electrode 7 and on its other face a metal shielding member 10.

More precisely, said shielding member is associated with or placed on or installed on the printed circuit 8. In other words, said shielding member is not kept offset or spaced with respect to said printed circuit, or connected indirectly to said printed circuit by the intermediary of a support.

This metal shielding member 10 is made of a conductive material, such as copper, zinc, gold, silver or any other conductive element or conductive composition of a type known per se.

Alternatively, this metal shielding member 10 has an openwork or textured structure or is in the form of a conductive mesh.

As shown in FIG. 4, said shielding member extends longitudinally and in a parallel manner over the whole length of at least one electrode.

Said shielding member and said electrodes have specific dimensions adapted to those of the desired final handle for the purpose of maximizing the detection zone over the length of the inside part of the handle and over its lower and upper parts.

Advantageously, depending on the thickness of said printed circuit, said shielding member is referenced to a floating or electric potential such as ground or to the measuring electrode.

FIGS. 5 and 6 respectively show a cross-sectional view of the electric field generated by the sensor according to the invention and a plan view of a handle and of the electric field generated by the sensor according to the invention.

These figures show that the electric field β produced by the sensor 6 according to the invention undergoes a flattening at the level of the outside part of the handle 1.

Said sensor 6 makes it possible to obtain an asymmetrical detection in the horizontal plane with respect to the door leaf, thus generating an optimum detection zone of capacitive variation which is reliable, precise and limited to this predefined space thus making it possible to avoid any parasitic detections and to apply its sensitivity within said zone.

Advantageously, the sensor 6 according to the invention also makes it possible to obtain a symmetrical detection in the vertical plane with respect to the door leaf, making it possible to produce identical left and right handles thus reducing production costs and facilitating assembly.

By way of illustrative example, the user who wants his or her door leaf to lock or unlock, brings all or part of a hand towards it in the vicinity of the lower, upper or inside parts of the handle. The authentication is carried out prior to or following the detection by said sensor. Said sensor according to the invention thus provides a detection zone limited to within a predefined space allowing a locking/unlocking of the door leaf only when these triggerings are desired.

It follows that the embodiment of the directive capacitive sensor described above has been given by way of example that is purely indicative and in no way limiting and that numerous modifications can be easily applied by those skilled in the art without by so doing departing from the scope of the invention.

### LEGEND

1. handle
2. grasping part of the handle
3. fixed part of the handle
4. door leaf of the vehicle
5. detection zone
6. directive capacitive approach sensor
7. measuring electrode
8. printed circuit
9. reference electrode
10. metal shielding member
α electric field produced by the sensor according to the prior art
β electric field produced by the sensor according to the invention

1. A capacitive approach sensor intended to be integrated in a door leaf handle for a vehicle, for the purpose of locking/unlocking of the vehicle door, comprising:
at least one electrode formed on a printed circuit in order to create a zone for detecting the presence of a user; and
at least one metal shielding member formed on said printed circuit.

2. The sensor as claimed in claim 1, wherein said at least one metal shielding member forms one of the faces of the printed circuit.

3. The sensor as claimed in claim 1, wherein said at least one metal shielding member extends longitudinally and in a parallel manner over a whole length of said at least one electrode.

4. The sensor as claimed in claim 1, wherein said at least one metal shielding member is a conductive material.

5. The sensor as claimed in claim 4, wherein said at least one metal shielding member is constituted by copper.

6. The sensor as claimed in claim 1, wherein said at least one metal shielding member has an openwork structure.

7. The sensor as claimed in claim 6, wherein said openwork structure is a conductive mesh.

8. The sensor as claimed in claim 1, wherein said at least one metal shielding member is referenced at an electric potential or is floating.

9. The sensor as claimed in claim 1, wherein said printed circuit has, on one of its faces, a reference electrode surrounded by a measuring electrode and, on its other face, a metal shielding member.

10. The sensor as claimed in claim 1, wherein the sensor comprises means of detection which are asymmetrical in the horizontal plane and symmetrical in the vertical plane, with respect to said door leaf.
